(19) United States
(12) Patent Application Publication
(10) Pub. No.: US 2011/0146118 A1
(43) Pub. Date: Jun. 23, 2011

(54) ILLUMINATED AERIAL AIRCRAFT DISPLAY

(76) Inventor: Jamsheed James Samadi, Leesburg, VA (US)

(21) Appl. No.: 12/978,053

(22) Filed: Dec. 23, 2010

Related U.S. Application Data
(60) Provisional application No. 61/289,991, filed on Dec. 23, 2009.

(51) Int. Cl. G09F 21/12; G09F 21/08

(52) U.S. Cl. 40/215; 40/212

(57) ABSTRACT

The present invention is an illuminated aerial aircraft display rowed by an airplane with a propeller with a front facing with a plurality of illuminated indicia that includes letters and numbers and illuminated computer generated or non-computer generated moving indicia or pictorial images disposed on the front facing and a wind milling generator installed on a lead pole of the illuminated aerial aircraft display and a plurality of LED lights that illuminate the illuminated indicia. The display has illuminated indicia that can utilize a wide variety of colors and aesthetically pleasing styles and works in combination with the propeller that spins and produces electricity used by the LED lights once the illuminated aerial aircraft display is picked up and towed by the aircraft. A battery can also be used to power the LED lights.

This application claims priority to U.S. Provisional Application 61/289,991 filed on Dec. 23, 2009, the entire disclosure of which is incorporated by reference.

### TECHNICAL FIELD & BACKGROUND

Aerial advertising by way of banner towing has always been a day time operation. There have been attempts to light-up banners behind aircraft with the use of spot lights on the aircraft which have not been successful. There are also systems available for blimps and small aircraft, by way of computerized moving letters, which are illuminated but are small and very hard to read, especially on the aircraft which have to be directly flown overhead to be seen and for urban areas where the aircraft must be no lower than 1500 feet above the ground.

The present invention generally relates to an illuminated display. More specifically, the invention is a portable illuminated aerial aircraft display.

It is an object of the invention to provide an illuminated aerial aircraft display that will illuminate banners and other advertising and display media towed by an aircraft at night.

It is an object of the invention to provide an illuminated aerial aircraft display that can provide aerial advertising and displays over cities and jammed highways at night, nighttime ball games and other nighttime events.

What is really needed is an illuminated aerial aircraft display that will illuminate banners and other advertising and display media towed by an aircraft at night and that can provide aerial advertising and displays over cities and jammed highways at night, nighttime ball games and other nighttime events.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates an environmental side perspective view of an illuminated aerial aircraft display and an aircraft, in accordance with one embodiment of the present invention.

FIG. 1B illustrates a side perspective view of an illuminated aerial aircraft display for basic indicia powered by an aircraft, in accordance with one embodiment of the present invention.

FIG. 1C illustrates a side perspective view of an illuminated aerial aircraft display for basic indicia powered by a battery, in accordance with one embodiment of the present invention.

FIG. 1D illustrates a front perspective view of a combination wing and parachute and wind milling generator housed in a cage with surrounding springs, in accordance with one embodiment of the present invention.

FIG. 2 illustrates an overhead perspective view of an illuminated aerial aircraft display for moving letters or pictorial images, in accordance with one embodiment of the present invention.

FIG. 3 illustrates a schematic electrical diagram of an illuminated aerial aircraft display, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

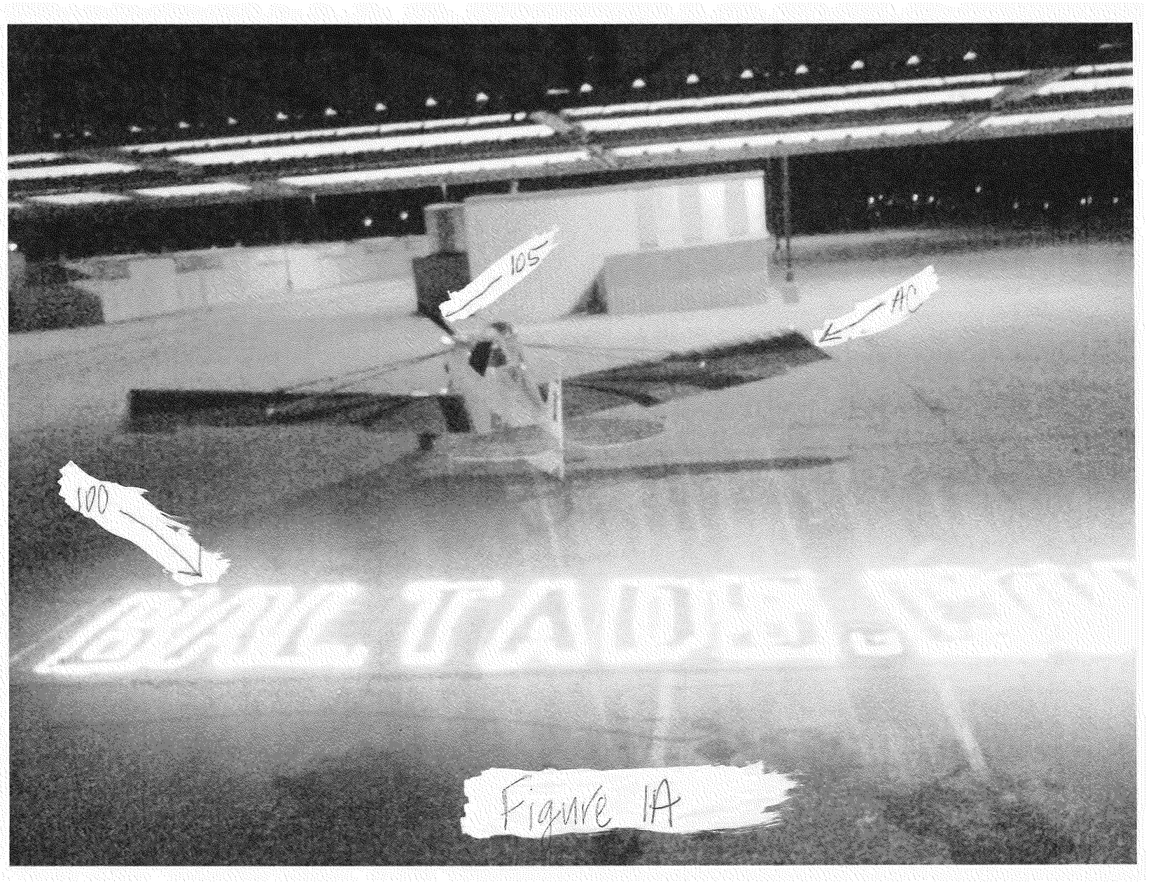

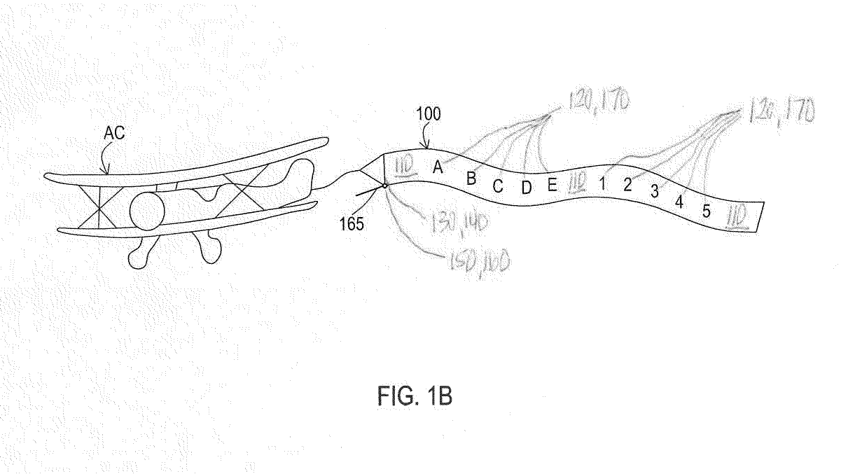

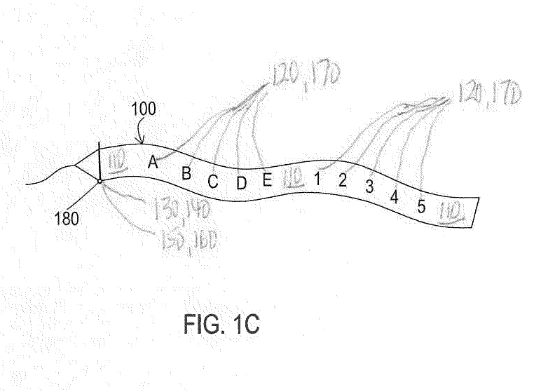

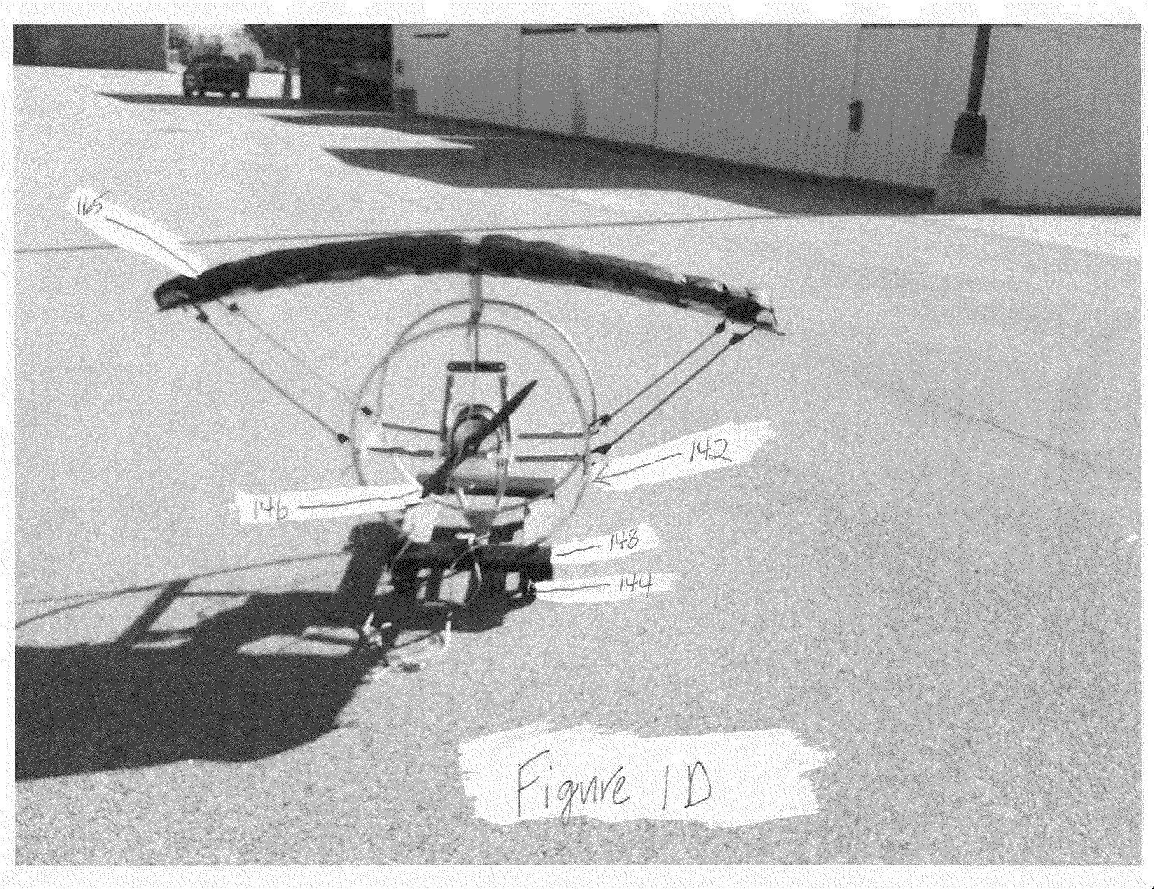

FIG. 1A illustrates an environmental perspective view of an illuminated aerial aircraft display 100 and an aircraft AC, in accordance with one embodiment of the present invention. The illuminated aerial aircraft display 100 can be towed by any aircraft AC of any size such as an airplane with a propeller 105. The illuminated aerial aircraft display 100 can be any material that can support the components of the illuminated aerial aircraft display 100 and is typically made of planar sheet-like material that can be easily towed by the aircraft AC and be easily seen at night.

FIG. 1B illustrates an overhead perspective view of an illuminated aerial aircraft display 100 powered by an aircraft AC, in accordance with one embodiment of the present invention. The illuminated aerial aircraft display 100 has a front facing 110 that has a plurality of illuminated indicia 120 such as letters and numbers disposed on the illuminated aerial aircraft display 100. The illuminated indicia 120 are approximately 5-7 feet high, although the illuminated indicia 120 can be other heights as well. The illuminated indicia 120 can be in a wide variety of colors and aesthetically pleasing styles.

One previous problem with trying to make an illuminated aerial aircraft display 100 has been getting electricity to the illuminated aerial aircraft display 100 to light up the illuminated indicia 120. The illuminated aerial aircraft display 100 has an electricity production unit 130, which is a wind milling generator 140 installed on the lead pole 150 of the bottom 160 of the illuminated aerial aircraft display 100, which replaces a weight unit (not shown) which is typically on other aerial aircraft displays. There is also a combination wing and parachute 165 to help lift and support some of the weight from the wind milling generator 140 and to assist if the wind milling generator 140 is dropped off of the illuminated aerial aircraft display 100. The wind milling generator 140 is also housed in a cage with surrounding springs to prevent damage when dropped off of the aircraft AC, as illustrated and described in FIG. 1D. Once the illuminated aerial aircraft display 100 is picked up and towed by the aircraft AC, the propeller 105 of the aircraft AC starts spinning and producing electricity, which in turn will be used to illuminate the illuminated indicia 120 with a plurality of LED lights 170. The wind milling generator 140 works in combination with the propeller 105 that spins and produces electricity to be used by the LED lights 170 or other types of lights.

FIG. 1C illustrates a side perspective view of an illuminated aerial aircraft display 100 for basic indicia powered by a battery 180, in accordance with one embodiment of the present invention. All of the features of the illuminated aerial aircraft display 100 are the same as the illuminated aerial aircraft display 100 embodiment described in the FIG. 1B description, except that this embodiment is not powered by the aircraft AC. This embodiment of the illuminated aerial aircraft display 100 is instead powered by a battery 180 disposed on the bottom 160 of the lead pole 150 to allow for the illuminated aerial aircraft display 100 to operate independent of any power from the aircraft AC.

FIG. 1D illustrates a front perspective view of a combination wing and parachute 165 and wind milling generator 140 housed in a cage 142 with surrounding springs 144, in accordance with one embodiment of the present invention. As previously described in the FIG. 1B description, the wind milling generator 140 is housed in a cage 142 and surrounding springs 144 to prevent damage when dropped off of the aircraft AC. The wind milling generator 140 is also provided with a propeller 146 to further ease impact on the wind milling generator 140 as it is released from an aircraft AC and lands on the ground and is set on a platform 148 for further stability.

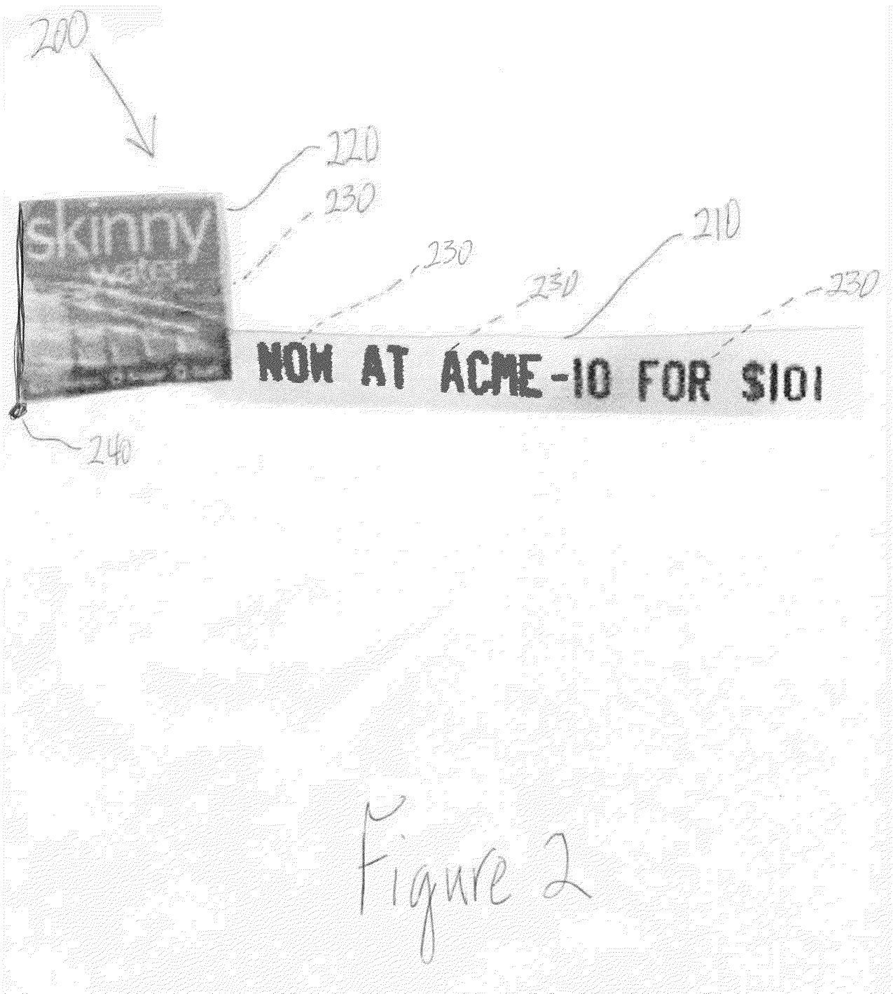

FIG. 2 illustrates an overhead perspective view of an illuminated aerial aircraft display 200 for moving letters 210 or pictorial images 220, in accordance with one embodiment of the present invention. The illuminated aerial aircraft display 200 can also be used to produce illuminated computer generated or non-computer generated moving indicia 210 or pictorial images 220 disposed on the illuminated aerial aircraft display 200. Like the illuminated indicia 120 described in the FIGS. 1A and 1B descriptions, the moving indicia 210 or pictorial images 220 disposed on the illuminated aerial aircraft display 200 are illuminated with a plurality of LED lights 230. Also like the illuminated indicia 120 described in the FIGS. 1A and 1B descriptions, once the illuminated aerial aircraft display 200 is picked up and towed by the aircraft AC, the propeller (105 in FIG. 1A) of the aircraft AC starts spinning and producing electricity, which in turn will be used to illuminate the moving indicia 210 or pictorial images 220 disposed on the illuminated aerial aircraft display 200 which are illuminated with a plurality of LED lights 230. A battery 240 can also be utilized to power the plurality of LED lights 230 independent from the aircraft AC as is described in the FIGS. 1A and 1B descriptions.

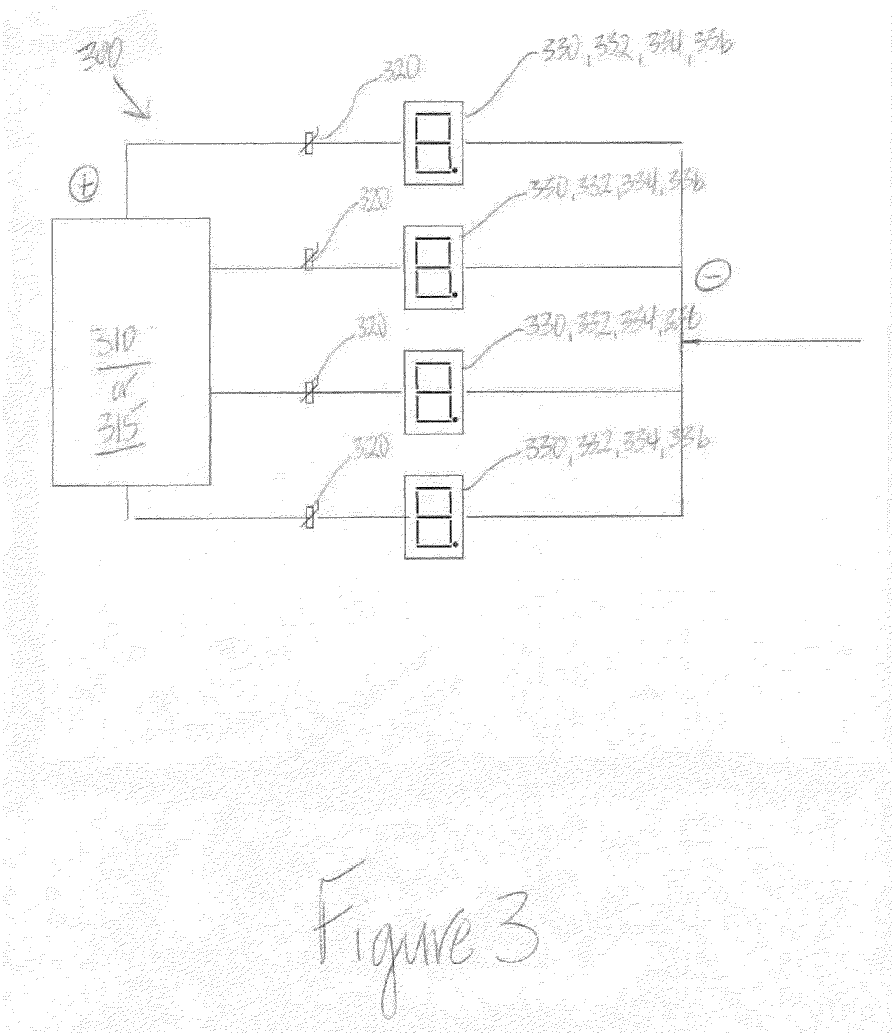

FIG. 3 illustrates a schematic diagram of an electrical system of an illuminated aerial aircraft display 300, in accordance with one embodiment of the present invention. The electrical system 300 includes a wind milling generator 310 and battery 315 previously described in the FIGS. 1A and 1B description, a plurality of variable resistors 320 and a plurality of LED lights 330 that can accommodate a plurality of illuminated indicia 332 such as letters and numbers or illuminated computer generated or non-computer generated moving indicia 334 or pictorial images 336. The LED technology for the plurality of illuminated indicia 332 such as letters and numbers or illuminated computer generated or non-computer generated moving indicia 334 or pictorial images 336 is known and used.

The illuminated aerial aircraft display 100 can also utilize other types of lights other than LED lights 170, 230 for illumination. Other electricity production units 130 can also be used to power the illuminated aerial aircraft display 100. The components of the illuminated aerial aircraft display 100 can also be used independently of an aircraft AC to illuminate fabric billboards as well.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An illuminated aerial aircraft display, comprising:
a front facing with a plurality of illuminated indicia disposed on said front facing;
an electricity production unit installed on a lead pole of said illuminated aerial aircraft display; and
a plurality of lights that illuminate said illuminated indicia using electricity produced by said electricity production unit.

2. The display according to claim 1, wherein said illuminated aerial aircraft display is towed by an airplane with a propeller.

3. The display according to claim 1, wherein said illuminated indicia include letters and numbers.

4. The display according to claim 1, wherein said illuminated indicia include illuminated computer generated or non-computer generated moving indicia or pictorial images.

5. The display according to claim 1, wherein said electricity production unit is a wind milling generator or battery.

6. The display according to claim 5, wherein said wind milling generator works in combination with said propeller that spins and produces electricity used by said lights once said illuminated aerial aircraft display is picked up and towed by said aircraft or a battery.

7. The display according to claim 6, wherein said propeller spins and produces electricity used by said lights once said illuminated aerial aircraft display is picked up and towed by said aircraft.

8. The display according to claim 5, wherein said wind milling generator is housed in a cage with a plurality of surrounding springs, a combination wing and parachute and a second propeller.

9. The display according to claim 1, wherein said lights are LED lights.

10. An illuminated aerial aircraft display towed by an airplane with a propeller, comprising:
a front facing with a plurality of illuminated indicia that include letters and numbers disposed on said front facing;
an electricity production unit installed on a lead pole of said illuminated aerial aircraft display; and
a plurality of LED lights that illuminate said illuminated indicia.

11. The display according to claim 10, wherein said illuminated indicia include illuminated computer generated or non-computer generated moving indicia or pictorial images.

12. The display according to claim 11, wherein said electricity production unit is a wind milling generator or battery.

13. The display according to claim 12, wherein said wind milling generator works in combination with said propeller that spins and produces electricity.

14. The display according to claim 13, wherein said propeller spins and produces electricity used by said LED lights once said illuminated aerial aircraft display is picked up and towed by said aircraft.

15. The display according to claim 13, wherein said wind milling generator is housed in a cage with a plurality of surrounding springs, a combination wing and parachute and a second propeller.

16. The display according to claim 10, wherein said illuminated aerial aircraft display is made of planar sheet-like material.

17. An illuminated aerial aircraft display towed by an airplane with a propeller, comprising:
a front facing with a plurality of illuminated indicia that includes letters and numbers and illuminated computer generated or non-computer generated moving indicia or pictorial images disposed on said front facing;
a wind milling generator installed on a lead pole of said illuminated aerial aircraft display; and
a plurality of LED lights that illuminate said illuminated indicia.

18. The display according to claim 17, wherein said wind milling generator works in combination with said propeller that spins and produces electricity used by said LED lights once said illuminated aerial aircraft display is picked up and towed by said aircraft or a battery.

19. The display according to claim 18, wherein said wind milling generator is housed in a cage with a plurality of surrounding springs, a combination wing and parachute and a second propeller.

20. The display according to claim 17, wherein said illuminated aerial aircraft display is made of planar sheet-like material.
